(19) United States
(12) Patent Application Publication
(10) Pub. No.: US 2009/0193339 A1
(43) Pub. Date: Jul. 30, 2009

(54) SOCIALLY-AUTHORED CONTEXT-INITIATED PROCESSES

(75) Inventors: Jeffrey W. Nichols, San Jose, CA (US); Tessa A. Lau, Mountain View, CA (US); Allen Cypher, Aptos, CA (US); James Lin, Cupertino, CA (US); Eben M. Haber, Cupertino, CA (US); Clemens Drews, San Jose, CA (US); Eric M. Wilcox, Cambridge, MA (US); Barton A. Smith, Campbell, CA (US)

Correspondence Address: FREDERICK W. GIBB, III;Gibb Intellectual Property Law Firm, LLC, 2568-A RIVA ROAD, SUITE 304, ANNAPOLIS, MD, 21401, US

(73) Assignee: INTERNATIONAL BUSINESS MACHINES CORPORATION, ARMONK, NY (US)

(21) Appl. No.: 12/021,783

(22) Filed: Jan. 29, 2008

(51) Int. Cl. G06F 9/44; G06F 3/048

(52) U.S. Cl. 715/744; 717/115; 715/810; 715/747

(57) ABSTRACT

Embodiments herein provide a method that maintains computerized scripts. The scripts provide assistance to users with respect to using at least one computer software application that is operating on a computerized device. The method receives, from the user, at least one trigger. This process creates or “authors” the trigger. This “trigger” is an item that automatically initiates at least one of the scripts for the user. In addition, the method adds the trigger to the computer software application (not automatically, but instead based on user input). Thus, when initiated by the trigger, the script automatically outputs assistance (text, sounds, illustrations, educational videos, etc.) to the user through the computerized interface of the computerized device, so as to provide the needed assistance to the user.

### BACKGROUND

1. Field of the Invention

The embodiments of the invention generally relate to the problem of providing assistance and automation to computerized devices, such as Web sites, and more particularly, the embodiments herein provide triggers for launching socially-authored scripts for automating tasks and for helping users solve questions regarding the use of computer applications.

2. Description of Related Art

Many web sites and computerized interfaces, especially in the enterprise environment, are large, complex and require users to go through multiple steps to complete a business process. Some of these sites provide help pages to assist with their usage, but a more common approach for users is to ask for help from a colleague who already has knowledge of the web site and the process. In view of this, embodiments herein automate and improve the help finding process using context from sources such as a web browser combined with the power of social networks.

### SUMMARY

Embodiments herein provide a method that maintains computerized scripts. The scripts provide assistance to users with respect to using at least one computer software application that is operating on a computerized device. The method receives, from the user, at least one trigger. This process creates or “authors” the trigger. A “trigger” is an association between a script that will be automatically invoked, and the context that defines when the script should be automatically invoked. Context could be any number of things, including (but not limited to) the receipt of an e-mail with a particular subject, visiting a web page with a particular word near the top, etc. Most generally, context can be anything that the computer can sense about the user or the user's environment. Thus, a trigger is an item that automatically initiates at least one of the scripts for the user. For example, a trigger can comprise an error message, a type of screen display, a file address, a universal resource locator (URL), specific text strings, etc.

In addition, the method adds the trigger to the computer software application (not automatically, but instead based on user input). Thus, when initiated by the trigger, the script automatically outputs instructions (text, sounds, illustrations, educational videos, etc.) to the user and/or automatically performs actions for the user in the software application(s) through the computerized interface of the computerized device, so as to provide the needed assistance to the user.

When the method receives (creates or authors) the triggers, it can do so in many ways. For example, the user can explicitly provide an explicit trigger that they have identified or created. Similarly, the method can receive, from an external entity distinct from the users, at least one trigger, which is sometimes referred to herein as a business trigger.

Alternatively, the user can implicitly provide the trigger. The process of implicitly providing the trigger tracks inputs into the computerized interface from the user and compares these inputs to processes performed by the scripts. When the inputs from the user match at least one process performed by at least one of the scripts, the method automatically identifies such an implicit trigger. Such an implicit trigger is based on the context of the computer software application at the moment when the inputs from the user match the process steps performed by the scripts.

Each of these types of triggers, the explicit trigger, the implicit trigger, and the business trigger, all automatically initiate at least one of the scripts for the user.

The process of adding the trigger to the computer software application also can be performed in a number of ways. For example, the user can access a list of triggers, and make selection of the trigger from the list of triggers maintained by a source of triggers. Alternatively, a more passive user can be asked whether they desire to add any triggers. For example, the method can provide an indication to the user that a trigger is available from a source of triggers. Upon receiving a positive indication from the user of a desire to add the trigger, the method can provide the user with the list of triggers. The user selection of one or more of the triggers received provides the basis for adding the trigger to the computer software application.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a method embodiment of the invention;

FIG. 2 is a flow diagram illustrating a method embodiment of the invention;

FIG. 3 is a flow diagram illustrating a method embodiment of the invention; and

FIG. 4 is a representative hardware environment for practicing the embodiments of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

Script creation and maintenance systems are known conventionally. For example, CoSripter (a computer script program available from International Business Machines Corporation, located in Armonk, N.Y., USA) is a system for recording and playing back scripts describing how to perform a web-based process, such as ordering business cards or searching for houses for sale.

When operating script software programs, users demonstrate on their computer how to perform a given task (teach); and the script software program automatically creates a script that can display the demonstration of this task in the future (e.g., to a future “student” who needs to learn how to perform the task). Thus, script based systems are used for recording, automating, and sharing processes performed, for example, in a web browser. These script programs allow users to make a recording as the user performs a procedure, play the recording back automatically in the future, and share the recording with other users. Thus, a script is a set of steps (e.g., a previously recorded demonstration, etc.) that are executable by a computerized device that will output a useful, concrete, and tangible result comprising a reproduction of the demonstration that was previously saved by the “teaching” user.

Further, scripts can be saved to a wiki where they can be shared with other users, enabling people to collectively define the “best practices” for accomplishing tasks. A wiki is software that allows users to create, edit, and link web pages easily. Wikis are often used to create collaborative websites and to power community websites. However, in the current script systems, users must come to the script system, find an appropriate script, and click on the script in order to start running the script. This requires users to know that there is a script relevant to their task, and switch contexts in order to invoke it.

There are also many trigger-based software programs that are commonly available. For example, some information triggers are systems for scheduling web-based reminders. When using such trigger software programs, users define triggers that display a particular URL based on particular events, such as visiting a web page, reaching a certain time, or viewing particular text on a web page. This disclosure provides a concept that is similar to scripts and triggers, but which uses triggers to allow scripts to be launched automatically when needed in a way that is appropriate for each specific user. Specifically, this disclosure describes methods for leveraging usage information and social networks to allow people to create, find, and share script triggers.

The invention can be broken down into an “authoring” aspect and a “using” aspect of script triggers. A “trigger” is an association between a script that will be automatically invoked, and the context that defines when the script should be automatically invoked. Context could be any number of things, including (but not limited to) the receipt of an e-mail with a particular subject, visiting a web page with a particular word near the top, etc. Most generally, context can be anything that the computer can sense about the user or the user's environment. Thus, a trigger is an item that automatically initiates at least one of the scripts for the user. For example, a trigger can comprise an error message, a type of screen display, a file address, a universal resource locator (URL), specific text strings, etc.

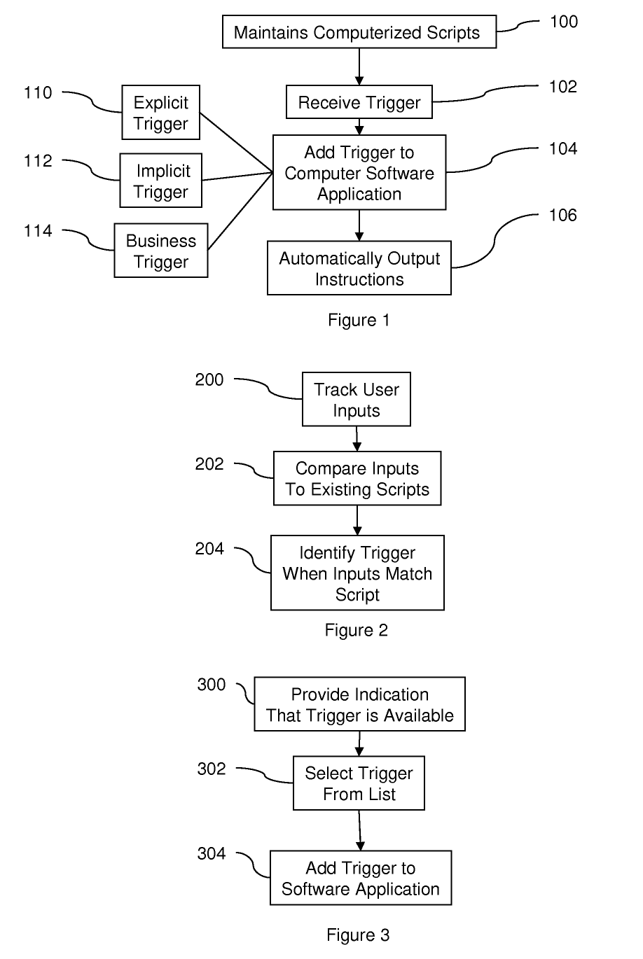

Users can author script triggers implicitly, explicitly, or receive them from external entities (such as online businesses). This is shown in flowchart form in FIG. 1.

More specifically, the embodiments herein provide a method that maintains computerized scripts in item 100. The scripts provide assistance to users with respect to using at least one computer software application that is operating on a computerized device. The method receives, from the user, at least one trigger in item 102. This process 102 creates or “authors” the trigger. This “trigger” is an item that automatically initiates at least one of the scripts for the user. For example, a trigger can comprise an error message, a type of screen display, a file address, a universal resource locator (URL), specific text strings, etc.

In addition, the method adds the trigger to the computer software application in item 104 (not automatically, but instead based on user input). Thus, when initiated by the trigger, the script automatically outputs instructions (text, sounds, illustrations, educational videos, etc.) to the user through the computerized interface of the computerized device, as shown by item 106, so as to provide the needed assistance to the user.

As shown in FIG. 1, when the method receives (creates or authors) the triggers, it can do so in many ways. For example, the user can explicitly provide an explicit trigger (item 110) that they have identified or created. With explicit authoring, the user manually specifies the trigger events, such as the arrival of an e-mail with particular contents or a visit to a web page at a specific URL, and a script that can provide appropriate automation or assistance when the trigger event occurs. Explicit authoring might be done through a dialog box in a web browser or e-mail client.

Alternatively, the user can implicitly provide the trigger (an implicit trigger 112). Similarly, the method can receive, from an external business entity that is distinct from the users, at least one trigger, which is sometimes referred to herein as a business trigger (item 114). Triggers authored by external entities, such as online businesses, offer a new business model based on triggers to drive business to a particular site. For example, a web site selling flowers might offer users a discount on a dozen roses if they allow that web site to install a trigger that automatically opens that site a few days before an important anniversary. The triggered link could make a coupon available if the link was opened at the proper time. Each of these types of triggers, the explicit trigger 110, the implicit trigger 112 (discussed in greater detail below) and the business trigger 114 all automatically initiate at least one script for the user.

An implicit trigger is based on the context of the computer software application at the moment when the inputs from the user match the process steps performed by the scripts. Thus, in implicit authoring, the system watches for situations in which the user begins using a script manually (without going through the trigger system). When the user beings using a script manually, the system attempts to infer from the user's current context the event that led that script to be useful, and saves this as a possible trigger that might be useful, either by this user or others. While the above covers the situation where the user manually performs the steps described in a script (when defining an implicit trigger), the embodiments herein also cover the case where the user explicitly invokes the script, but does not explicitly define the trigger. In this case the system can also infer an implicit trigger, based on the context present when the user selected the script.

The context of the computer software application can be specified with different granularity. The context includes attributes of the user's computing environment, including but not limited to: the current application, the windows visible on screen, the content being displayed in each application, the email being displayed, the web page visible on screen, etc. More generally, the context includes the state of the phone (off the hook/on the hook), the noise volume in an office, a user's physical location, etc. Most broadly, the context can be anything that the computer can sense about the user or the user's environment.

At a coarse level, the URL for the current web page could be the context. Finer levels are also possible, by recognizing particular content within the page. For example, when the user encounters an error message while working through a process on a web page, information triggers could recognize the error from text on the page and automatically invoke the appropriate script to help the user recover from that particular error.

The process of implicitly providing the trigger is shown in flowchart form in FIG. 2. This process tracks inputs into the computerized interface from the user (item 200) and compares these inputs to processes performed by the scripts (item 202). When the inputs from the user match at least one process performed by at least one of the scripts, the method automatically identifies such an implicit trigger (item 204).

Users can add triggers to their environment in several ways. For example, the user can visit the script web site where there are a number of methods for browsing and searching the available scripts. When the user finds a script they are interested in, they can also view a list of triggers that others have created for that script.

Triggers can be sorted by a number of methods, including the user's proximity to the creator in a social network. This latter method helps users find triggers that are likely to be relevant to their computing environment and business needs. Users can select one or more triggers and add them to their environment.

Alternatively, when the user is operating the computer, a small non-disruptive alert (such as the appearance of a small icon in an out-of-the-way location of the screen) may appear to indicate that a trigger is available for the user's current context. If the user is interested, the icon can be clicked to explore the possible triggers and scripts for that context and the user may choose to add one or more appropriate triggers to their environment. The user may filter the triggers suggested by the system using various means, such as to triggers created by users within a specified proximity in the social network, and/or to popular triggers, etc.

An additional way in which triggers can be added is the situation where the user encounters an error condition and a trigger exists for this condition. In such a situation, the system may prompt the user with a more intrusive alert, such as a small animated notification window or a centrally-placed message dialog, to indicate that help is available. As with the previously discussed embodiments, these intrusive alerts could be filtered, presumably with more restrictions. The creator of the trigger can specify whether the trigger is used in an error condition and should be accorded higher priority, and other users can vote on whether or not this trigger should receive such a priority.

The system does not automatically enable the new trigger for the current user, though it might passively notify the user that a new trigger was created by making a small, non-disruptive icon appear somewhere within the user's environment. Thus, in order to “use” a trigger to open a script, in some embodiments herein people have to explicitly add the trigger to their environment. This is an advantage over other context-aware help systems, which will automatically assist with a variety of tasks even if the user already knows how to do them and does not require assistance.

The process of adding the trigger to the computer software application also can be performed in a number of ways. For example, as shown in FIG. 3, the user can simply go to a script web site, access a list of triggers, and make selection of the trigger from the list of triggers maintained by a source of triggers, as shown in item 302. Alternatively, a more passive user can be prompted (with varying degrees of intrusion, as discussed above) as to whether they desire to add any triggers as shown in item 300. For example, the method can provide an indication to the user that a trigger is available from a source of triggers. Upon receiving a positive indication from the user of a desire to add the trigger the method can provide the user with the list of triggers, as shown in item 302. The user selection of one or more of the triggers (item 304) received provides the basis for adding the trigger to the computer software application. The user may also add multiple triggers as a batch operation, for example by “subscribing” to the set of triggers maintained by a “trusted” user (e.g., someone in their social network).

Thus, as shown above, the embodiments herein establish an integrated application triggering system that can provide assistance to users when they need assistance, encounter an error, or wish to automate a time-consuming or tedious process. While some embodiments herein are described in terms of web-based applications specifically, these embodiments are generally applicable to all traditional software applications, such as word processors, spreadsheets, databases, image creation software, and other software.

For example, after selecting an item to purchase and proceeding to a web checkout, users will be presented with several screens and a number of options that must be correctly specified to complete their orders. In this case, the checkout screen would be the context and an information trigger would automatically launch a script to help the person complete the checkout process. People could use the social aspects of a script web site to find a checkout script that is appropriate to their location and department.

Traditional help systems are separated from the application for which they are providing help. In order to get assistance with their problem, users must be able to map their problem/process into the language used by the help system in order to find an adequate solution, interpret the instructions from the help system, and correctly translate those instructions into a set of correct actions with the application. To the contrary, the triggers used with embodiments herein allow assistance to be provided at the moment it is necessary, rather than requiring a search of the help system and interpretation of the results. Scripts provide structured assistance within the user's environment, so the user does not need to interpret instructions from the help system into their current context. The social aspects of a combined script and trigger system allows the trigger and the help system to be customized to the attributes of the user, such as locale.

One conventional script system is the Microsoft paperclip system (available from Microsoft Corporation Redmond, Wash., USA). This system is able to make use of context to provide some simple help within the application. U.S. Pat. No. 6,657,643 (the complete disclosure of which is incorporated herein by reference) describes the behavior of the paper clip agent, which uses probabilistic models to govern the actions of the agent. The possible behaviors of the agent are inaction, automatic action, or engaging the user in a dialog about the user's desire for automated action, followed by action pending receipt of user approval. Similarly, U.S. Pat. No. 7,003,525 (the complete disclosure of which is incorporated herein by reference) pertains to the identification of contextual information, such as used in the paperclip, and its use for notification. In both of these patents, the behaviors and contextual cues are authored by the provider of the agent, in this case Microsoft, and not by the user or a group of users, as in the scripts and triggers of the present embodiments. Scripts and triggers of embodiments herein also go further by providing support for multi-step mixed-initiative procedures integrated with the application (the paper clip did not support multi-step collaborative interactions).

Greasemonkey® (a web browser extension available from Mozilla Corporation, Mountain View, Calif., USA) allows users to specify arbitrary JavaScript® code (available from Sun Microsystems, Inc., Santa Clara, Calif. 95054) that executes when a web page is loaded. Platypus® (available from Platypus Technologies, Madison, Wis., USA) provides a straight-forward authoring environment for a class of Greasemonkey® scripts that modify loaded pages based on content found within the page. These techniques provide one possible way for identifying content and authoring an appropriate trigger, but they cannot support the integrated assistance across multiple web pages that scripts of the present embodiments can.

There are a number of patents around the construction, presentation, and use of social networks for rating and enhancing the scripts that are available, and a detailed discussion of such items are not included herein. For example, see U.S. Pat. No. 7,069,308 (the complete disclosure of which is incorporated herein by reference) that pertains to the way in which a social network might be stored, viewed, and assembled within a computer system. Also, U.S. Patent Publication 2004/0148275 (the complete disclosure of which is incorporated herein by reference) describes a method for doing information discovery within a social network that is privacy-aware. Rather than display search results, the system instead helps the user navigate to the desired information while making decisions about how much help to provide based on privacy issues. Thus, conventional socialized authoring of content only creates passive information or links between entities, rather than providing active assistance as the present embodiments do.

The embodiments herein can take the form of an entirely hardware embodiment, an entirely software embodiment or an embodiment including both hardware and software elements. The embodiments that are implemented in software include, but are not limited to, firmware, resident software, microcode, etc. Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

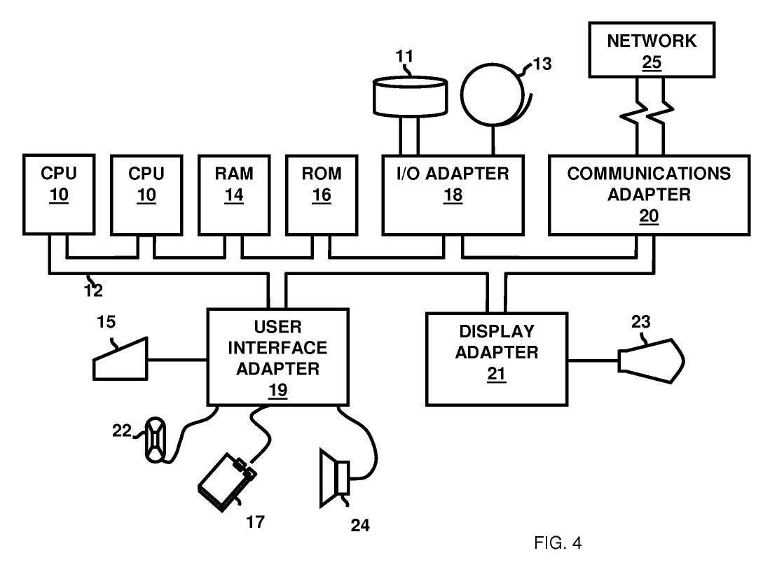

A representative hardware environment for practicing the embodiments of the invention is depicted in FIG. 4. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

What is claimed is:

1. A method comprising:
maintaining computerized scripts adapted to provide assistance to users with respect to using at least one computer software application operating on a computerized device;
receiving, from a user, at least one trigger, wherein said trigger is adapted to automatically initiate at least one of said scripts for said user; and
adding said trigger to said computer software application based on user input,
wherein, when initiated by said trigger, said script is adapted to automatically output said assistance to said user through a computerized interface of said computerized device so as to provide said assistance to said user.

2. The method according to claim 1, all the limitations of which are incorporated herein by reference, wherein said receiving comprises said user explicitly providing an explicit trigger, wherein said explicit trigger is adapted to automatically initiate at least one of said scripts for said user.

3. The method according to claim 1, all the limitations of which are incorporated herein by reference, wherein said receiving comprises said user implicitly providing said trigger, wherein said implicitly providing of said trigger comprises:
tracking inputs into said computerized interface from said user;
comparing said inputs to processes performed by said scripts; and
automatically identifying an implicit trigger when said inputs from said user match at least one process performed by at least one of said scripts,
wherein said implicit trigger is based on a context of said computer software application when said inputs from said user match said process steps performed by said scripts, and
wherein said implicit trigger is adapted to automatically initiate at least one of said scripts for said user.

4. The method according to claim 1, all the limitations of which are incorporated herein by reference, further comprising receiving, from an external entity distinct from said users, at least one business trigger, wherein said business trigger is adapted to automatically initiate at least one of said scripts for said user.

5. The method according to claim 1, all the limitations of which are incorporated herein by reference, wherein said adding of said trigger to said computer software application comprises receiving a user selection of said trigger from a list of triggers maintained by a source of triggers, wherein said adding of said trigger is based on said user selection.

6. The method according to claim 1, all the limitations of which are incorporated herein by reference, said adding of said trigger to said computer software application comprises:
providing an indication to said user that a trigger is available from a source of triggers;
receiving a positive indication from said user of a desire to add said trigger;
upon receiving said positive indication, providing said user with said list of triggers; and
receiving a user selection of one or more of said triggers to be added to said computer software application from said user,
wherein said adding of said trigger is based on said user selection.

7. The method according to claim 1, all the limitations of which are incorporated herein by reference, wherein said trigger comprises at least one of: an error message; a type of screen display; a file address; a universal resource locator (URL); and specific text strings.

8. A method comprising:
maintaining computerized scripts adapted to provide assistance to users with respect to using at least one website rendered by a web browser operating on a computerized device;
receiving, from a user, at least one trigger, wherein said trigger is adapted to automatically initiate at least one of said scripts for said user; and
adding said trigger to said website based on user input,
wherein, when initiated by said trigger, said script is adapted to automatically output said assistance to said user through a computerized interface of said computerized device so as to provide said assistance to said user.

9. The method according to claim 8, all the limitations of which are incorporated herein by reference, wherein said receiving comprises said user explicitly providing an explicit trigger, wherein said explicit trigger is adapted to automatically initiate at least one of said scripts for said user.

10. The method according to claim 8, all the limitations of which are incorporated herein by reference, wherein said receiving comprises said user implicitly providing said trigger, wherein said implicitly providing of said trigger comprises:
tracking inputs into said computerized interface from said user;
comparing said inputs to processes performed by said scripts; and
automatically identifying an implicit trigger when said inputs from said user match at least one process performed by at least one of said scripts,
wherein said implicit trigger is based on a context of said website when said inputs from said user match said process steps performed by said scripts, and
wherein said implicit trigger is adapted to automatically initiate at least one of said scripts for said user.

11. The method according to claim 8, all the limitations of which are incorporated herein by reference, further comprising receiving, from an external entity distinct from said users, at least one business trigger, wherein said business trigger is adapted to automatically initiate at least one of said scripts for said user.

12. The method according to claim 8, all the limitations of which are incorporated herein by reference, wherein said adding of said trigger to said website comprises receiving a user selection of said trigger from a list of triggers maintained by a source of triggers, wherein said adding of said trigger is based on said user selection.

13. The method according to claim 8, all the limitations of which are incorporated herein by reference, wherein said adding of said trigger to said website comprises:
providing an indication to said user that a trigger is available from a source of triggers;
receiving a positive indication from said user of a desire to add said trigger;
upon receiving said positive indication, providing said user with said list of triggers; and
receiving a user selection of one or more of said triggers to be added to said website from said user,
wherein said adding of said trigger is based on said user selection.

14. The method according to claim 8, all the limitations of which are incorporated herein by reference, wherein said trigger comprises at least one of: an error message; a type of screen display; a file address; a universal resource locator (URL); and specific text strings.

15. A program storage device tangibly embodying a program of instructions executable by a computerized device, wherein said program of instructions cause said computerized device to perform a method comprising:
maintaining computerized scripts adapted to provide assistance to users with respect to using at least one computer software application operating on a computerized device;
receiving, from a user, at least one trigger, wherein said trigger is adapted to automatically initiate at least one of said scripts for said user; and
adding said trigger to said computer software application based on user input,
wherein, when initiated by said trigger, said script is adapted to automatically output said assistance to said user through a computerized interface of said computerized device so as to provide said assistance to said user.

16. The program storage device according to claim 15, all the limitations of which are incorporated herein by reference, wherein said receiving comprises said user explicitly providing an explicit trigger, wherein said explicit trigger is adapted to automatically initiate at least one of said scripts for said user.

17. The program storage device according to claim 15, all the limitations of which are incorporated herein by reference, wherein said receiving comprises said user implicitly providing said trigger, wherein said implicitly providing of said trigger comprises:
tracking inputs into said computerized interface from said user;
comparing said inputs to processes performed by said scripts; and
automatically identifying an implicit trigger when said inputs from said user match at least one process performed by at least one of said scripts,
wherein said implicit trigger is based on a context of said computerized software application when said inputs from said user match said process steps performed by said scripts, and
wherein said implicit trigger is adapted to automatically initiate at least one of said scripts for said user.

18. The program storage device according to claim 15, all the limitations of which are incorporated herein by reference, wherein said method further comprises receiving, from an external entity distinct from said users, at least one business trigger, wherein said business trigger is adapted to automatically initiate at least one of said scripts for said user.

19. The program storage device according to claim 15, all the limitations of which are incorporated herein by reference, wherein said adding of said trigger to said computerized software application comprises receiving a user selection of said trigger from a list of triggers maintained by a source of triggers, wherein said adding of said trigger is based on said user selection.

20. The program storage device according to claim 15, all the limitations of which are incorporated herein by reference, wherein said adding of said trigger to said computerized software application comprises:
providing an indication to said user that a trigger is available from a source of triggers;
receiving a positive indication from said user of a desire to add said trigger;
upon receiving said positive indication, providing said user with said list of triggers; and
receiving a user selection of one or more of said triggers to be added to said computerized software application from said user,
wherein said adding of said trigger is based on said user selection.
